(19) United States
(12) Patent Application Publication
(10) Pub. No.: US 2005/0270275 A1
(43) Pub. Date: Dec. 8, 2005

(54) Scrolling device of human interface device and human interface device using the same

(76) Inventor: Deok-Young Jung, Yongin-city (KR)

Correspondence Address: CANTOR COLBURN, LLP, 55 GRIFFIN ROAD SOUTH, BLOOMFIELD, CT, 06002, US

(21) Appl. No.: 11/113,585

(22) Filed: Apr. 25, 2005

(30) Foreign Application Priority Data
Jun. 4, 2004 (KR) 2004-41065

(51) Int. Cl. G09G 5/00

(52) U.S. Cl. 345/173

(57) ABSTRACT

A scrolling device of human interface device and human interface device using the same is disclosed. The scrolling device of human interface device includes a plurality of touch sensing pads and performs scroll operation by sensing contact of at least one of the plurality of touch sensing pads. Thus, it is possible to prevent a mechanical noise and malfunction caused by mechanical abrasion. Further, it is possible to sense upward and downward scroll movement as well as leftward and rightward scroll movement, thus providing still more various scroll information, so that it is possible to make good use of the scrolling device of human interface device.

### CROSS-REFERENCE TO RELATED APPLICATION

This application claims the benefit of Korean Patent Application No. 2004-41065, filed on Jun. 04, 2004, the contents of which are hereby incorporated herein by reference in their entirety.

### BACKGROUND OF THE INVENTION

1. Field of the Invention

The present invention relates to human interface device and, more particularly, to a scrolling device of human interface device.

2. Description of the Related Art

Currently, personal computing devices are widely distributed and used by almost all people. Each personal computing device has a human interface device (HID) connected and receives data from the HID and receives data from the HID to perform corresponding operation.

The HID generally stands for any device, which supports a person to conveniently process an interface with a computing device and/or its peripherals. One example of the HID may include a keyboard, a mouse, a wireless sensor, a mobile phone, a digital camera or so forth.

In particular, the invention is directed to scrolling device of HID, scrolling device of HIDs is a device that generates a scroll signal to allow a screen of the computer to move up and down, unlike a movement calculating movement of the mouse.

In below, it will now be adopted that adopted mouse as embodiment of HIDs, and described it for explaining the present invention more easily.

The mouse scrolling device which is generally used at present is externally similar to a wheel of a toy vehicle but, in fact, internally composed of a mixture of electrical and mechanical devices. The mouse scrolling device may be exemplified as follows: one generating a scroll signal based on movement of a wheel (i.e., upward and downward scroll movement), or one employing an image sensor sensing movement of a user to generate the resulting scroll signal.

FIG. 1 illustrates a mouse scrolling device using a wheel according to the prior art, and FIG. 2 illustrates a mouse scrolling device using an image sensor according to the prior art.

Now, referring to FIG. 1, a wheel scrolling device is composed of a circular scroll wheel 1 of a rubber material so as to permit a user to perform scroll operation with ease; a circular wheel switching unit 3 connected with the circular scroll wheel 1 through a connection rod 2, provided with switches 3a through which a current flows and with contacts 3b connected between the switches 3a, and generating a switch intermittent pattern; and a scroll signal converter 4 obtaining rotational direction and speed of the wheel switching unit 3 from the switch intermittent pattern of the wheel switching unit 3 which is generated by making the current to flow through the switches 3a of the wheel switching unit 3.

For the wheel scrolling device of FIG. 1, when a user turns the scroll wheel 1 with his/her finger in order to generate the scroll signal, the wheel switching unit 3 is turned by a rotational force of the scroll wheel 1. The scroll signal converter 4 senses the rotational direction and speed of the wheel switching unit 3, then generating and outputting the scroll signal in response to the sensed result.

For the purpose of easy description, the wheel scrolling device has been shown in a simple structure, but in fact has a more complicated structure mechanically and electrically.

This mouse scrolling device of FIG. 1 has been widely used up to now because of inexpensive production costs of a product. The wheel switching unit 3 is configured of a mechanical switch as shown in the figure, so that there is a possibility to generate a noise at the contacts generating the switch intermittent pattern.

Further, when being used for a long time, the mouse scrolling device of FIG. 1 is inevitably subjected to abrasion of the mechanical switch, thus causing malfunction.

Meanwhile, the mouse scrolling device using the image sensor of FIG. 2 is composed of a light source 5 for irradiating a subject or target 6, an image sensor 7 for obtaining a current image of the subject 6 using a quantity of light which is reflected on the subject 6 and inputted through the lens (not shown), and a scroll signal converter 8 for calculating movement direction and speed of the mouse using current and previous images of the subject 6 which are obtained through the image sensor 7, and generating a scroll signal in response to the calculated result.

However, the mouse scrolling device using the image sensor of FIG. 2 requires an image sensor and a control process having the similar configuration as a camera in order to precisely obtain the image of the subject 6. Further, the image sensor and the scroll signal converter which process the image should be realized by a semiconductor circuit device. For this reason, the mouse scrolling device of FIG. 2 has a drawback in that production costs of a product are increased.

Further, much electric power is consumed to drive the light source. For example, the mouse such as a wireless mouse where driving electric power is supplied from a chargeable battery has a problem in that its available time is reduced.

In this manner, the conventional mouse scrolling device detects upward and downward movement of the subject to thereby generate the scroll signal by use either of the electrical intermittent signal generated by mechanical rotation as in the mouse scrolling device of FIG. 1 or the image sensor as in the mouse scrolling device of FIG. 2.

As such, the various types of scrolling devices which have been widely used up to now are of bad performance over a price or too expensive over performance.

Further, with the mouse scrolling device of FIG. 1, motion of the user is sensed using the scroll wheel and the wheel switching unit connected to the scroll wheel, so that only upward and downward movement can be sensed. Therefore, there is a disadvantage in that leftward and rightward movement can not be sensed.

Hence, there is increased a need for a new scrolling device making it possible to perform precise scroll operation at a low cost and low consumption electric power. Further, as an applicable range of the mouse becomes diversified, a need for the scrolling device making it possible to sense upward and downward scroll movement of the user as well as leftward and rightward scroll movement to generate the resulting scroll signal is increased as well.

### SUMMARY OF THE INVENTION

It is, therefore, an objective of the present invention to provide a scrolling device of human interface device capable of always generating a stable scroll signal using a plurality of touch sensing pads and sensing upward and downward scroll movement as well as leftward and rightward scroll movement.

It is another objective of the present invention to a scrolling device of human interface device capable of always generating a stable scroll signal using a plurality of photodetectors and sensing upward and downward scroll movement as well as leftward and rightward scroll movement.

It is yet another objective of the present invention to provide a human interface device capable of obtaining information on a scrolling direction from a scrolling device using a plurality of touch sensing pads and stably generating a scroll signal for making it possible to scroll a screen of a computer up and down as well as left and right.

It is still yet another objective of the present invention to provide a human interface device capable of obtaining information on a scrolling direction from a scrolling device using a plurality of photodetectors and stably generating a scroll signal for making it possible to scroll a screen of a computer up and down as well as left and right.

In order to accomplish the objectives, according to a first aspect of the invention, there is provided a touch sensing pad scrolling device of human interface device, which comprises a plurality of touch sensing pads and performing scroll operation by changing the information of contacted location and sensing contact of at least one of the plurality of touch sensing pads 2. The scrolling device of human interface device as set forth in claim 1, further comprising a plurality of contact sensors connecting with the plurality of touch sensing pads respectively and each of the contact sensors generating a sensed signal in response to a value of resistance or capacitance generated when a contact object is brought into contact with the corresponding touch sensing pad.

According to a second aspect of the invention, there is a scrolling device of human interface device, which comprises a plurality of holes and a plurality of photo detectors disposed to have a pattern corresponding to the plurality of holes, and performing scroll operation by changing the information of contacted location by sensing blocking light from passing through at least one of the plurality of holes.

According to a third aspect of the invention, there is provided a mouse which comprises touch sensing pad a scrolling device of the human interface device having a plurality of touch sensing pads and performing scroll operation by changing the information of contacted location and sensing contact of at least one of the plurality of touch sensing pads; and a contact sensor providing sensed signals having information of contacted location of by sensing contact of at least one of the plurality of touch sensing pads.

According to a fourth aspect of the invention, there is provided a human interface device comprising a scrolling device of man interface device, the scrolling device of man interface device including a plurality of holes and a plurality of photodetectors disposed to have a pattern corresponding to the plurality of holes and performing scroll operation by changing the information of contacted location by sensing blocking light from passing through at least one of the plurality of holes.

### BRIEF DESCRIPTION OF THE DRAWINGS

The foregoing and other objects, features and advantages of the invention will be apparent from the more particular description of an exemplary embodiment of the invention, as illustrated in the accompanying drawing. The drawing is not necessarily to scale, emphasis instead being placed upon illustrating the principles of the invention.

FIG. 1 illustrates a mouse scrolling device using a wheel according to the prior art;

FIG. 2 illustrates a mouse scrolling device using an image sensor according to the prior art

FIGS. 3A-3D illustrates a mouse scrolling device according to one embodiment of the invention;

FIG. 4 illustrates a scroll signal generator of a mouse employing the mouse scrolling device of FIG. 3A-3D;

FIGS. 5A-5E illustrates a mouse scrolling device according to another embodiment of the invention;

FIG. 6 illustrates a scroll signal generator of a mouse employing the mouse scrolling device of FIG. 5A; and

FIG. 7 illustrates a mouse employing a mouse scrolling device of the invention.

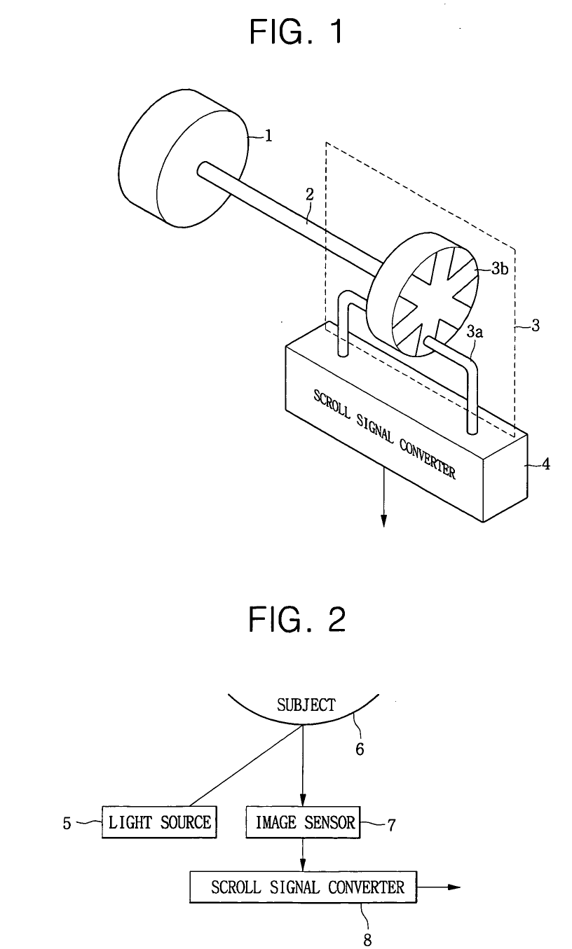

### DETAILED DESCRIPTION OF THE INVENTION

The present invention will now be described more fully hereinafter with reference to the accompanying drawings, in which exemplary embodiments of the invention are shown. In the drawings, the thickness of the layers and regions are exaggerated for clarity.

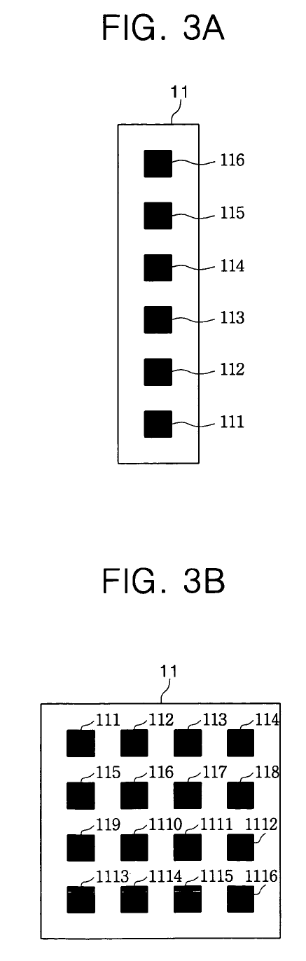

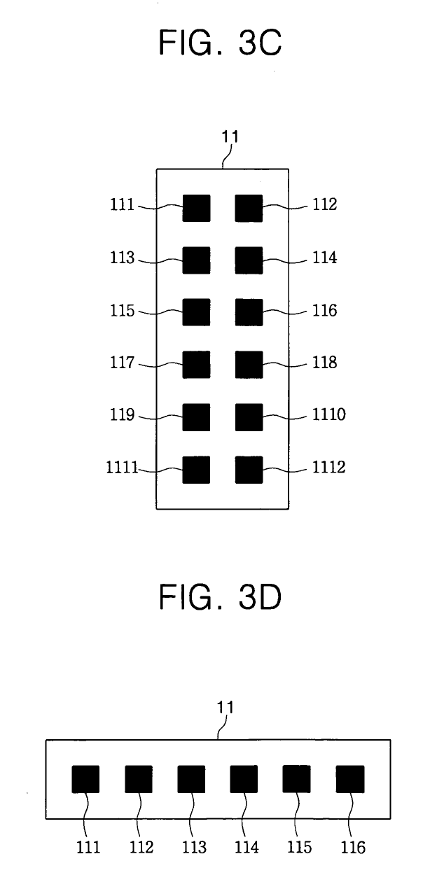

FIGS. 3A-3D illustrates a mouse scrolling device according to one embodiment of the invention.

As shown in FIGS. 3A-3D, the scrolling device of the invention includes a plurality of touch sensing pads 111-116.

The plurality of touch sensing pads 111-116 generates a value of resistance or capacitance respectively when coming into contact with a contact object, but it is kept opened when not coming into contact with the contact object.

For the scrolling device 11, the plurality of touch sensing pads 111-116 are arranged in various forms as in FIGS. 3A-3D.

Thus, the scrolling device 11 provides information on a contact position of the contact object using an operational characteristic that only the touch sensing pad(s) corresponding to a region where the contact object is brought into contact generates the resistance or capacitance value.

Taking it as an example that the scrolling device 11 is arranged as in FIG. 3A, when the contact object is brought into contact with a lower side of the scrolling device 11, the touch sensing pads 111-113 located on the lower side of the scrolling device 11 generates the resistance or capacitance value, the touch sensing pads 114-116 located on an upper side of the scrolling device 11 are kept opened. Thereby, the scrolling device 11 informs that the contact object comes into contact with the lower side thereof.

Thus, the scrolling device 11, which has the plurality of touch sensing pads 111-116 arranged in a line up and down (i.e., in a longitudinal direction) as in FIG. 3A, makes it possible to detect on which of upper and lower sides the contact object is located.

The scrolling device 11, which has the plurality of touch sensing pads 111-1116 similarly arranged up and down and left and right (e.g., in a square (4×4) matrix form) as in FIG. 3B, makes it possible to readily detect the upper and lower positions of the contact object as well as left and right positions.

Further, the scrolling device 11, which has the plurality of touch sensing pads 111-1112 arranged up and down more than left and right (e.g., in a rectangular (2×4) matrix form) as in FIG. 3C, makes it possible to readily detect the upper and lower positions of the contact object and simultaneously left and right positions of the contact object to a certain extent.

The scrolling device 11, which has the plurality of touch sensing pads 111-116 arranged in a row left and right (i.e., in a traverse direction) as in FIG. 3D, makes it possible to detect on which of left and right sides the contact object is located.

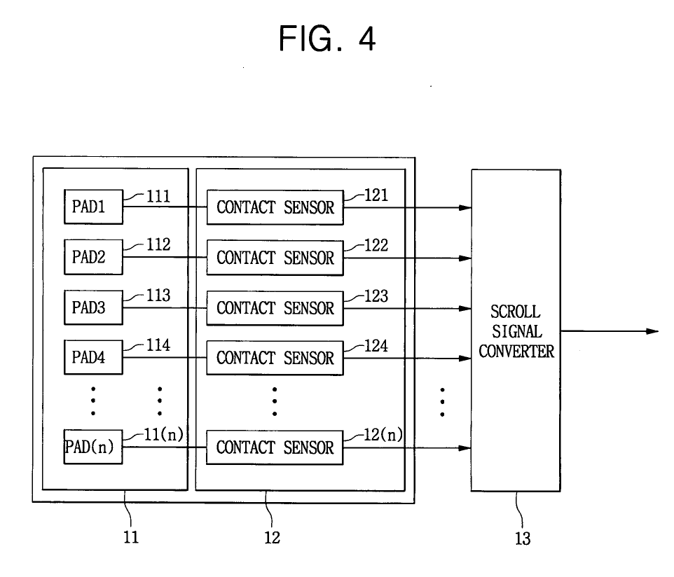

FIG. 4 illustrates a scroll signal generator of a mouse employing the mouse scrolling device of FIG. 3A-3D.

Continuously referring to FIG. 4, the scroll signal generator of the invention includes a plurality of touch sensing pads 111-11n of the scrolling device 11, a plurality of contact sensors 121-12n, and a scroll signal converter 13.

The plurality of contact sensors 121-12n are connected with plurality of touch sensing pads 111-11n of the scrolling device 11, respectively.

Thus, each (e.g. 121) of the contact sensors 121-12n generates a sensed signal in response to a value of resistance or capacitance generated when a contact object is brought into contact with the corresponding touch sensing pad 111.

The scroll signal converter 13 combines the plurality of sensed signals outputted from the plurality of contact sensors 121-12n of the scrolling device 11 to thus obtain a contact position of the contact object, namely, information on a scrolling direction.

In response to this information, the scroll signal converter 13 generates the scroll signal for scrolling a screen of a computer.

For example, when the scrolling device 11 is arranged as in FIG. 3A, and when the contact object is not brought into contact with all the touch sensing pads 111-11n and thus all the contact sensors 121-12n do not output the sensed signals, it is determined that scroll operation is not requested, and thus the scroll signal is not generated.

When each of the plurality of contact sensors 121-12n corresponding to the touch sensing pads located either on the upper side or on upper and lower sides of the scrolling device 11 generates and outputs the sensed signal informing that the contact object is brought into contact, the scroll signal converter 13 determines that the contact object was brought into contact with the upper side of the scrolling device 11, thereby generating the scroll signal for moving the computer screen in an upward direction.

By contrast, when each of the plurality of contact sensors 121-123 located on the lower side of the scrolling device 11 outputs the sensed signal informing that the contact object is brought into contact, the scroll signal converter 13 determines that the contact object was brought into contact with the lower side of the scrolling device 11, thereby generating the scroll signal for moving the computer screen in an downward direction.

Alternatively, in order to implement an operation as in an existing mechanical scrolling device by use of another sensing method, a movement value of a region where the contact is sensed may be calculated, and thereby the computer screen may be moved.

With the same method, the scroll signal is generated to move the computer screen in a leftward or rightward direction.

And in the above-mentioned invention, the scrolling device has only a plurality of touch sensing pads but the scrolling device could have the plurality of touch sensing pads and the contact sensors as occasion demands.

The above-mentioned description has been made regarding the mouse scrolling device having the plurality of touch sensing pads is employed, and the mouse using the scrolling device.

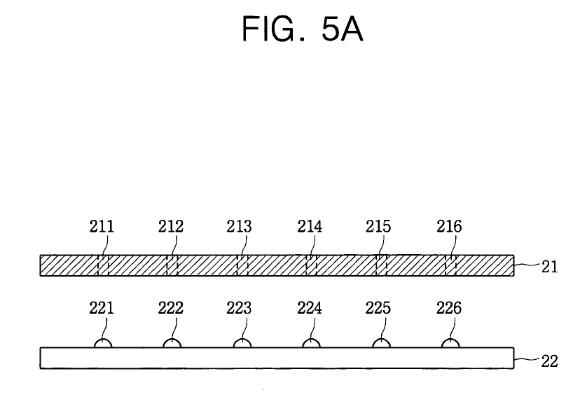

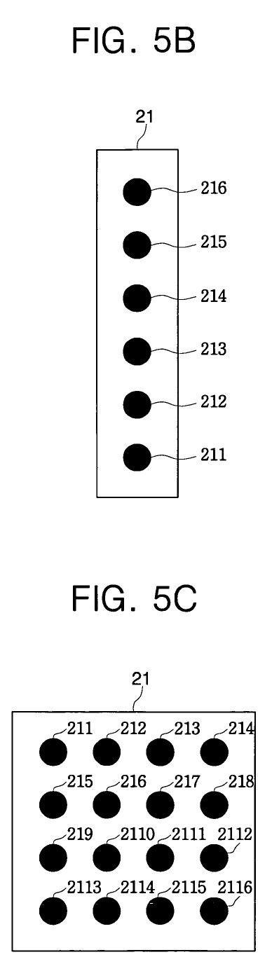

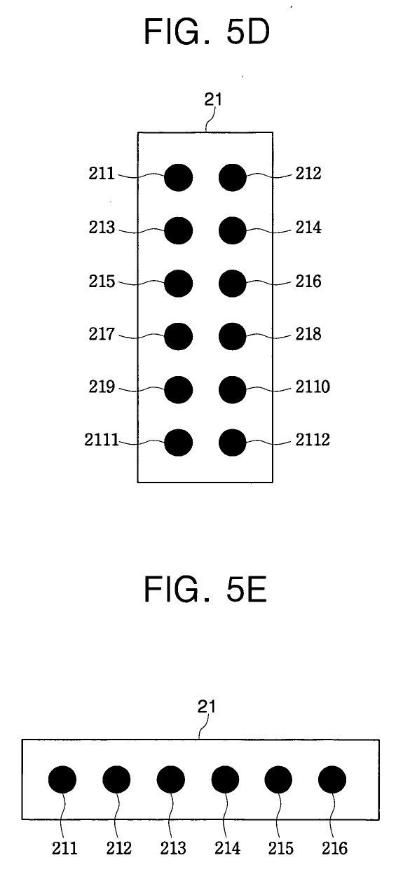

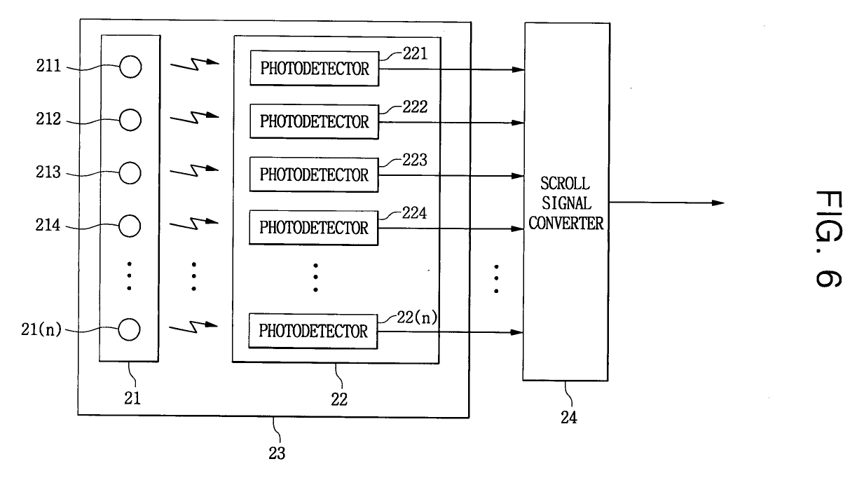

With the exception of the foregoing mouse scrolling device, there is another mouse scrolling device designed to the scroll signal by use of a plurality of photodetectors, together with a mouse using another mouse scrolling device, which will be described below with reference to FIGS. 5A-5E and 6.

FIG. 5A-5E illustrates a mouse scrolling device according to another embodiment of the invention.

Specifically, FIG. 5A is a side view showing a panel 21 and a photodetecting section 22, FIGS. 5B-5E illustrate configurations where a plurality of holes 211-216 of the panel 21 and a plurality of photodetectors 221-226 of the photodetecting section 22 are arranged.

Referring to FIG. 5A, the scrolling device of the invention includes the panel 21 and the photodetecting section 22, wherein the panel 21 is provided with the plurality of holes, and the photodetecting section 22 is disposed opposite to the panel 21 in parallel and has the plurality of photodetectors 221-22n disposed to correspond to the plurality of holes of the panel 21.

Since a human being makes use of the mouse, working with the mouse is largely performed under the environment where light exists such that the human being can recognize a thing.

In other words, when the contact object comes into contact with any hole of any photodetector the photodetector fails to receive the light through the hole and thus generates a first signal having an insufficient voltage level. However, when the contact object does not come into contact with any hole of any photodetector, the photodetector—receives the light through the hole—and thus generates a second signal having a sufficient voltage level.

Thus, the photodetecting section 22 of FIG. 5A-5E can provide a contact position of the contact object, i.e., information on the scrolling direction similarly to the the contact sensors 121-12n of FIG. 4.

In this case, the holes of the panel 21 and the photodetectors 221-22n of the photodetecting section 22 can be arranged as in FIG. 5B, 5C, 5D or 5E.

The arrangement configuration of FIG. 5B makes it possible to detect on which of upper and lower sides the contact object is located. The arrangement configuration of FIG. 5C makes it possible to detect the upper and lower positions of the contact object as well as left and right positions. The arrangement configuration of FIG. 5D makes it possible to readily detect the upper and lower positions of the contact object and simultaneously left and right positions of the contact object to a certain extent. The arrangement configuration of FIG. 5E makes it possible to detect on which of left and right sides the contact object is located.

In this case, either a photo diode or a thin film device may be used as the photodetectors 221-22n.

FIG. 6 illustrates a scroll signal generator of a mouse employing the mouse scrolling device of FIG. 5A-5E, wherein the scroll signal generator includes a scrolling device 23 and a scroll signal converter 24.

The panel 21 of the scrolling device 23 has a plurality of holes and is mounted on an upper surface of the mouse for easy use of the user. Each photodetector of the photodetecting section 22 is opposite to the panel 21 in parallel and disposed to correspond to each hole of the panel 21, thus generating an electrical signal corresponding to a quantity of light incident through each corresponding hole.

Thereby, the scroll signal converter 24 obtains a contact position of the contact object, i.e. information on the scrolling direction, from the plurality of electrical signals outputted from the plurality of photodetectors 221-22n of the photodetecting section 22. In response to this information, the scroll signal converter 24 generates the scroll signal for scrolling the computer screen.

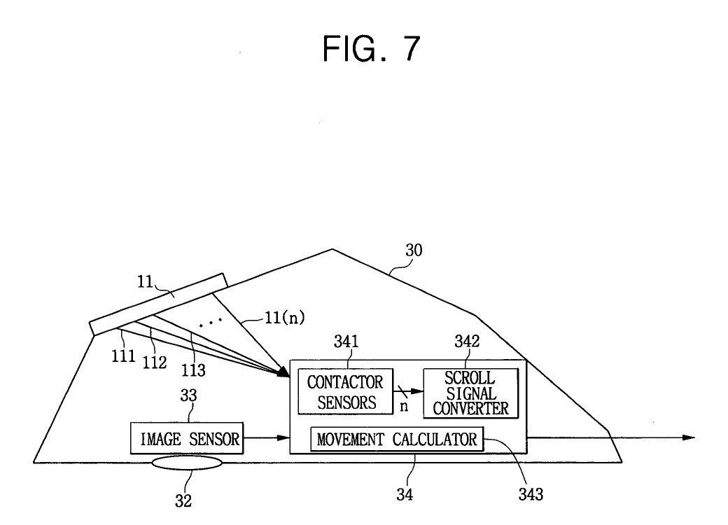

FIG. 7 illustrates a mouse using a mouse scrolling device of the invention.

Referring to FIG. 7, the mouse of the invention is composed of a scrolling device 11 of FIG. 3, disposed on the upper surface of the mouse, a lens 32 disposed on a lower surface of the mouse, an image sensor 33 for obtaining an image of an subject through the lens 32, and a semiconductor calculating section 34 for generating a scroll signal in response to a plurality of values of resistance or capacitance generated through the scrolling device 11 and calculating and generating a value of movement of the mouse from the subject image obtained through the image sensor 33.

The semiconductor calculating section 34 includes a plurality of contact sensors 341 which are connected with the plurality of touch sensing pads 111˜11n of scrolling device 11 and generate electrical signals corresponding to the resistance or capacitance values of the touch sensing pads 111˜11n, a scroll signal converter 342 for generating the scroll signal in response to output signals of the plurality of contact sensors 341, and a movement calculator 343 for calculating the movement value of the mouse by comparing the subject image provided from the image sensor 33.

Thus, the semiconductor calculating section 34 detects a contact position of the contact object which is brought into contact with the scrolling device 11 through the plurality of contact sensors 341, and then generates the scroll signal reflecting the detected result through the scroll signal converter 342.

Here, the semiconductor calculating section 34 may be realized by a semiconductor device. Therefore, it is possible to minimize wasting production costs and layout generated by the plurality of contact sensors 341 and the scroll signal converter 342.

As set forth above, the present invention detects the position where the contact object comes into contact using a plurality of contact sensors each of which has a touch sensing pad, and generates the scroll signal for scrolling the computer screen to correspond to the contacted position.

Here, each of the contact sensors may be realized by a simple electric circuit capable of sensing that the contact object having the capacitance and conductance components is brought into contact with at least one touch sensing pad. Therefore, it is possible to reduce production costs of the product and to prevent a mechanical noise and malfunction caused by mechanical abrasion.

Further, arrangement of the plurality of touch sensing pads make it possible to sense upward and downward scroll movement as well as leftward and rightward scroll movement, thus providing still more various scroll information. Consequently, it is possible to make good use of the mouse scrolling device.

In addition, when the scroll signal is intended to be generated by a plurality of photodetectors, the inexpensive device such as a thin film device is employed as each photodetector to detect the position where the contact object comes into contact. Thus, it is possible to reduce production costs of the product and to prevent a mechanical noise and malfunction caused by mechanical abrasion.

In the above-mentioned invention, the present invention is selected a mouse as embodiment of human interface device and confined a mouse scrolling device of human interface device as the scrolling device of human interface device.

But that the concept of the present invention could apply to keyboard, a wireless sensor, a mobile phone, a digital camera or so forth is no wonder.

And Exemplary embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1. A scrolling device of human interface device comprising a plurality of touch sensing pads and contact sensors and performing scroll operation by sensing contact locations of at least one of the plurality of touch sensing pads and changes of information of said contacted locations,
wherein the touch sensing pads are connected to the contact sensors, respectively.

2. The scrolling device of human interface device as set forth in claim 1, wherein the contact sensor generating a sensed signal in response to a value of resistance or capacitance generated when a contact object is brought into contact with the corresponding touch sensing pad.

3. The scrolling device of human interface device as set forth in claim 1, wherein the plurality of touch sensing pads are arranged in a line up and down.

4. The scrolling device of human interface device as set forth in claim 1, wherein the plurality of touch sensing pads are arranged in a predetermined pattern up and down and left and right.

5. The scrolling device of human interface device as set forth in claim 1, wherein the plurality of touch sensing pads are arranged in a row left and right.

6. A human interface device comprising:
a scrolling device of the human interface device having a plurality of touch sensing pads and performing scroll operation by sensing contact location of at least one of the plurality of touch sensing pads and changes of information of said contacted locations; and
a contact sensors providing sensed signals having information of contacted location of by sensing contact of at least one of the plurality of touch sensing pads,
wherein the direct touch sensing pads are connected to contact sensors, respectively.

7. The human interface device as set forth in claim 6, wherein the plurality of touch sensing pads are arranged in a line up and down.

8. The human interface device as set forth in claim 6, wherein the plurality of touch sensing pads are arranged in a predetermined pattern up and down and left and right.

9. The human interface device as set forth in claim 6, wherein the plurality of touch sensing pads are arranged in a row left and right.

10. The human interface device as set forth in claim 6, wherein the sensed signal is generated by a value of resistance or capacitance of a contact object brought into contact with the touch sensing pads.

11. The human interface device as set forth in claim 6, further comprising a scroll signal converter for generating a scroll signal in response to the sensed signal provided from the contact sensor.

12. The human interface device as set forth in claim 6, further comprising a movement calculator for calculating a value of movement when movement is sensed, wherein the movement calculator and the contact sensor are realized by a semiconductor device.

13. A scrolling device of human interface device comprising a plurality of holes and a plurality of photodetectors disposed to have a pattern corresponding to the plurality of holes, and performing scroll operation by changing the information of contacted location by sensing blocking light from passing through at least one of the plurality of holes.

14. The scrolling device of human interface device as set forth in claim 13, wherein the plurality of holes are arranged in a line up and down.

15. The scrolling device of human interface device as set forth in claim 13, wherein the plurality of touch sensing pads are arranged in a predetermined pattern up and down and left and right.

16. The scrolling device of human interface device as set forth in claim 13, wherein the plurality of touch sensing pads are arranged in a row left and right.

17. A human interface device comprising;, the scrolling device of man interface device including a plurality of holes and a plurality of photodetectors disposed to have a pattern corresponding to the plurality of holes and performing scroll operation by changing the information of contacted location by sensing blocking light from passing through at least one of the plurality of holes.

18. The human interface device as set forth in claim 17, wherein the plurality of holes are arranged in a line up and down.

19. The human interface device as set forth in claim 17, wherein the plurality of touch sensing pads are arranged in a predetermined pattern up and down and left and right.

20. The human interface device as set forth in claim 17, wherein the plurality of touch sensing pads are arranged in a row left and right.

21. The human interface device as set forth in claim 17, wherein the photodetectors are each composed of any one of a photo diode and a thin film which generating a signal having a value corresponding to a quantity of incident light.

22. The human interface device as set forth in claim 17, further comprising a scroll signal converter for generating a scroll signal in response to the sensed signal provided to the scrolling device.

23. The human interface device as set forth in claim 22, further comprising a movement calculator for calculating a value of movement when movement is sensed, wherein the movement calculator, a contact sensor, and the scroll signal converter are realized by a semiconductor device.
